(19) United States
(12) Patent Application Publication
(10) Pub. No.: US 2006/0053058 A1
(43) Pub. Date: Mar. 9, 2006

(54) System and method for gathering consumer feedback

(76) Inventors: Philip Hotchkiss, Minneapolis, MN (US); Matthew Dornquast, Minneapolis, MN (US)

Correspondence Address: Devan V. Padmanabhan, Esq.;DORSEY & WHITNEY LLP, Intellectual Property Department, Suite 1500, 50 South Sixth Street, Minneapolis, MN, 55402-1498, US

(21) Appl. No.: 11/216,466

(22) Filed: Aug. 31, 2005

Related U.S. Application Data
(60) Provisional application No. 60/605,954, filed on Aug. 31, 2004.

(51) Int. Cl. G06Q 30/00; G07G 1/00

(52) U.S. Cl. 705/14; 705/10

(57) ABSTRACT

An electronic system and method for gathering consumer feedback and reporting the feedback. The system and method provides an incentive for engaging the consumer to register and answer a survey. The registration information and answers provided are compiled into a database and may be formatted into reports. The gathering of the feedback and the reporting may be done in real-time. Information from the survey may be used to communicate or market to targeted users. Thus, the present invention relates to an electronic system and method for achieving registration, gathering consumer feedback via a survey, and communicating or marketing to targeted users based on survey results.

### CROSS REFERENCE TO RELATED APPLICATION(S)

This present utility application claims the benefit of U.S. Provisional Application Ser. No. 60/605,954, filed Aug. 31, 2004, subject matter of which is incorporated herewith by reference.

### FIELD OF THE INVENTION

The present invention relates generally to a system and method for gathering and reporting consumer feedback. More specifically, the present invention relates to an electronic system and method for achieving registration, gathering consumer feedback via a survey, and communicating or marketing to targeted users based on survey results.

### BACKGROUND OF THE INVENTION

Surveys are often used to gather information from consumers. However, such surveys are typically lengthy and administered in person or over the telephone. Consumers are generally not attracted to filling out the survey. Even when a survey is filled out, when the survey is administered in person or by hand, the gathered information must separately be input into a database or system. Only after the information has been input into the database can it be analyzed.

### BRIEF SUMMARY OF THE INVENTION

The present invention relates generally to a system and method for gathering and reporting consumer feedback. More specifically, the present invention relates to a system and method for gathering consumer feedback in real time and reporting the consumer feedback to a commissioning entity. The invention collects and protects consumer data on behalf of a retailer or other commissioning entity. The data gathered is aggregated and delivered in real time through an online reporting tool that allows the retailer to conduct analyses based on defined business objectives. A campaign may be developed tailoring questions and incentives to the research objectives and merchandising objectives. Additionally, the campaign develops the registration email that is sent to participants, the sweepstakes rules, and the privacy policy. The gathered information enables the retailer to make decisions to address short-term and long-term consumer needs.

The system of the present invention includes at least one data collection device at a remote location, such as a store, communicating with a server. The communication need not require a persistent connection. The data collection device administers surveys for gathering consumer information.

In use, a retailer (or other entity) commissions a survey for gathering consumer feedback or other information. The provider creates a campaign for the retailer. When launched, each campaign includes an incentive to participate, a short, focused survey, and a request for registration. Each data collection device runs the campaign.

In accordance with the present invention, a consumer is attracted by an incentive to fill out a survey. The consumer registers at the data collection device by providing a contact address such as an email address. Registration triggers a registration confirmation response from the server. The response may be specifically tailored to the campaign and may include a return incentive, that is, an incentive to cause the consumer to return to a site of the commissioning entity, for example a real site such as a retail location or a website.

Each survey is designed to engage the consumer and gather feedback from the consumer. A survey created in accordance with the present invention is brief and focused. Upon completion of the initial survey, the consumer may be asked to answer additional survey questions. Reward offers may be used to entice the consumer to answer the additional questions. Reward offers may be provided in near real-time.

Using the invention, the provider may receive real-time (generally within about fifteen minutes of the survey) transmission of the consumer's registration information and survey answers. The registration information and/or survey answers are compiled into a database. The information in the database can be formatted into reports. The database may be queried, to produce a report, for particular groups of respondents or using specific criteria. The gathered information is reported to an entity, such as a retailer, commissioning the survey.

The system of the present invention provides an online reporting tool to enable the retailer (or other commissioning entity) to view the customer survey results in real time. In accordance with the invention, the commissioning entity can create, print and download reports based on at least the following interactive criteria: campaign, remote location(s), date range, day part, demographics, or custom criteria.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 illustrates a block diagram of a system for gathering consumer feedback in accordance with one embodiment of the present invention.

FIG. 2a illustrates a flow chart of a method for gathering consumer feedback in accordance with one embodiment of the present invention.

FIG. 2b illustrates a flow chart of data collection in accordance with one embodiment of the present invention.

FIG. 3 illustrates an incentive advertised on a data collection device in accordance with one embodiment of the present invention.

FIG. 4 illustrates sample survey sheets in accordance with one embodiment of the present invention.

FIG. 5 illustrates an example thank you response in accordance with one embodiment of the present invention.

FIG. 6 illustrates a sample report in accordance with one embodiment of the present invention.

FIG. 7 illustrates a data collection device in accordance with one embodiment of the present invention.

FIG. 8 illustrates a virtual keyboard of a data collection device in accordance with one embodiment of the present invention.

FIG. 9 illustrates an overview of the operation of a data collection system in accordance with one embodiment of the present invention.

FIG. 10 illustrates a block diagram of data collection device detail in accordance with one embodiment of the present invention.

FIG. 11 illustrates a block diagram of data collection detail via a browser in accordance with one embodiment of the present invention.

FIG. 12 illustrates a block diagram of commissioning entity detail in accordance with one embodiment of the present invention.

FIG. 13 illustrates a block diagram of a provider server in accordance with one embodiment of the present invention.

### DETAILED DESCRIPTION OF THE INVENTION

The present invention relates generally to an electronic system and method for gathering and reporting consumer feedback. More specifically, the present invention relates to an electronic system and method for achieving registration, gathering consumer feedback via a survey, and communicating or marketing to targeted users based on survey results. The invention collects and protects consumer data on behalf of a commissioning entity, for example, a retailer. A campaign, described more fully below, may be developed tailoring questions and incentives to research, merchandising, marketing and other objectives. Additionally, the campaign develops a registration confirmation such as an email that is sent to participants, sweepstakes rules, and a privacy policy. The data gathered via the campaign is aggregated and delivered in approximately real time through an online reporting tool that allows the commissioning entity to conduct analyses based on defined business objectives. The gathered information enables the retailer to make decisions to address short-term and long-term consumer needs. Further, the present invention supports an ongoing dialog with the consumer by rewarding the consumer for their time and effort through a program of targeted and relevant communications, such as emails, designed with incentives to return the consumer to a site of the commissioning entity, for example a retail store or a website. This dialog can then be the basis of further research or of marketing.

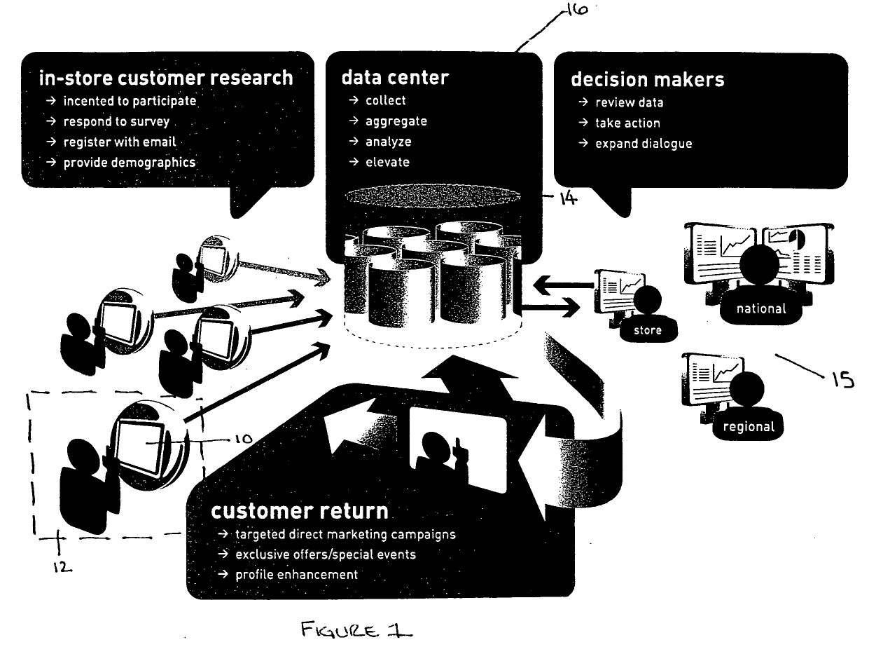

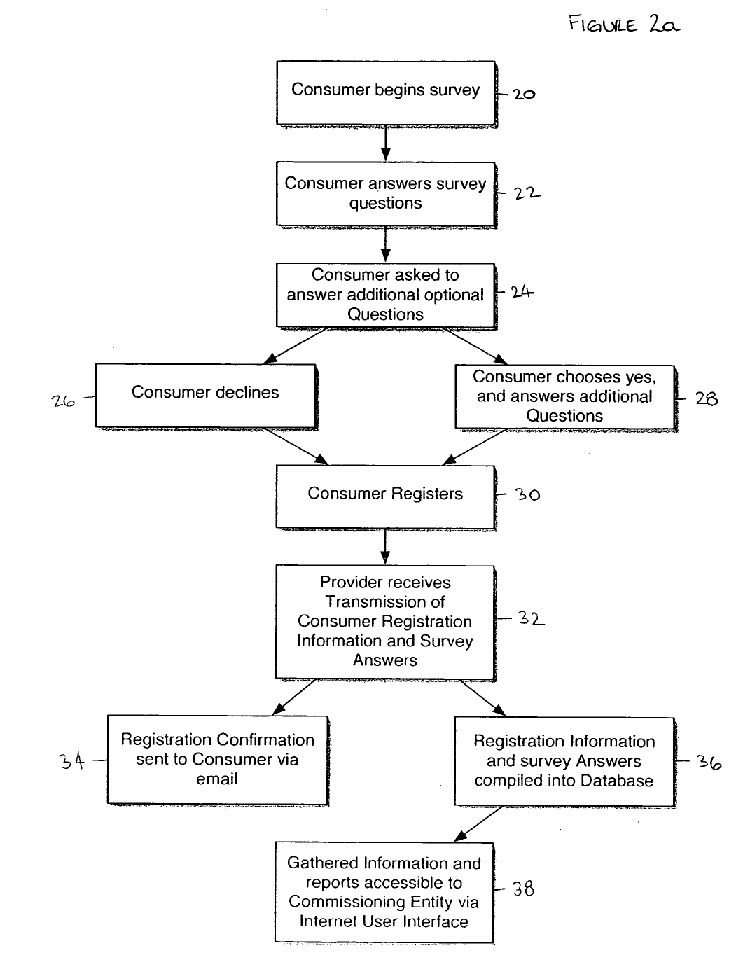

As shown in FIG. 1, the system of the present invention includes at least one data collection device 10 at a remote location 12, such as a store, communicating with a server 14. The data collection device 10 administers surveys for gathering consumer information. At the data collection device 10, a user is incentivized to participate, responds to a survey, registers by giving a contact address, and provides demographic information. The server 14 (discussed more fully below) monitors the stations(s) 10, processes information from the station(s) 10 and maintains the stations(s) 10. The server 14 collects information from the station(s) 10, aggregates the data, and analyzes the data. The data may be transmitted to a commissioning entity 15 where the data may be reviewed.

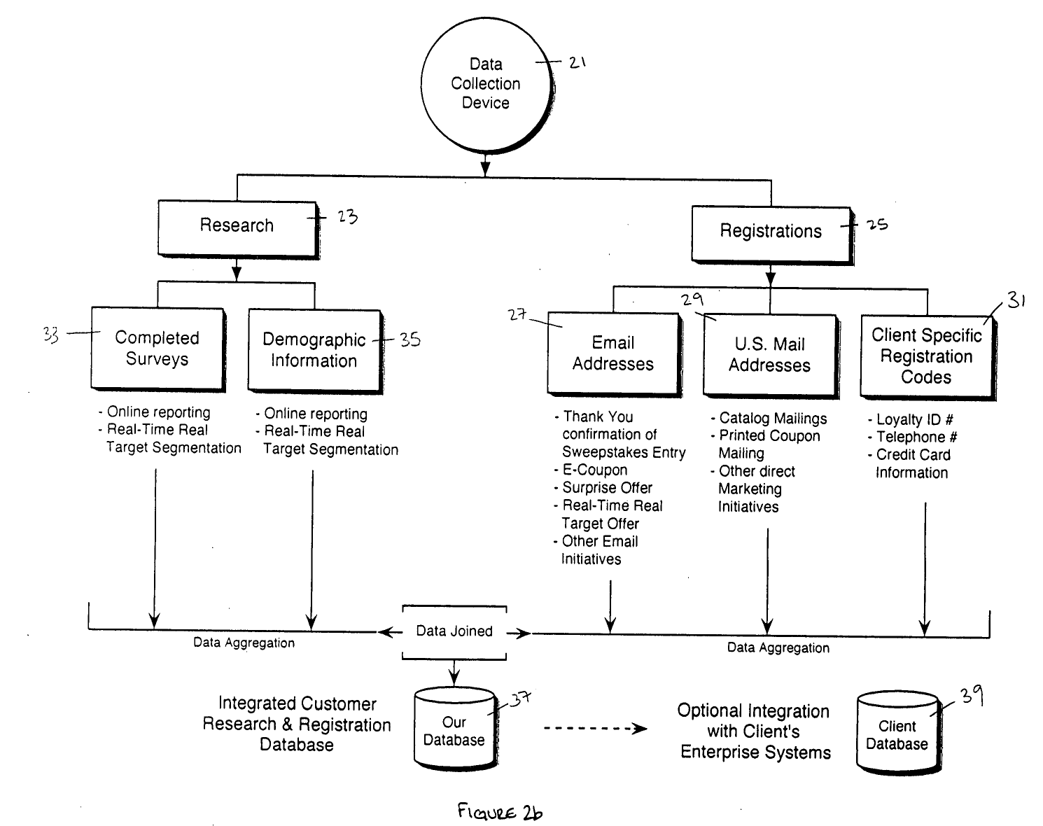

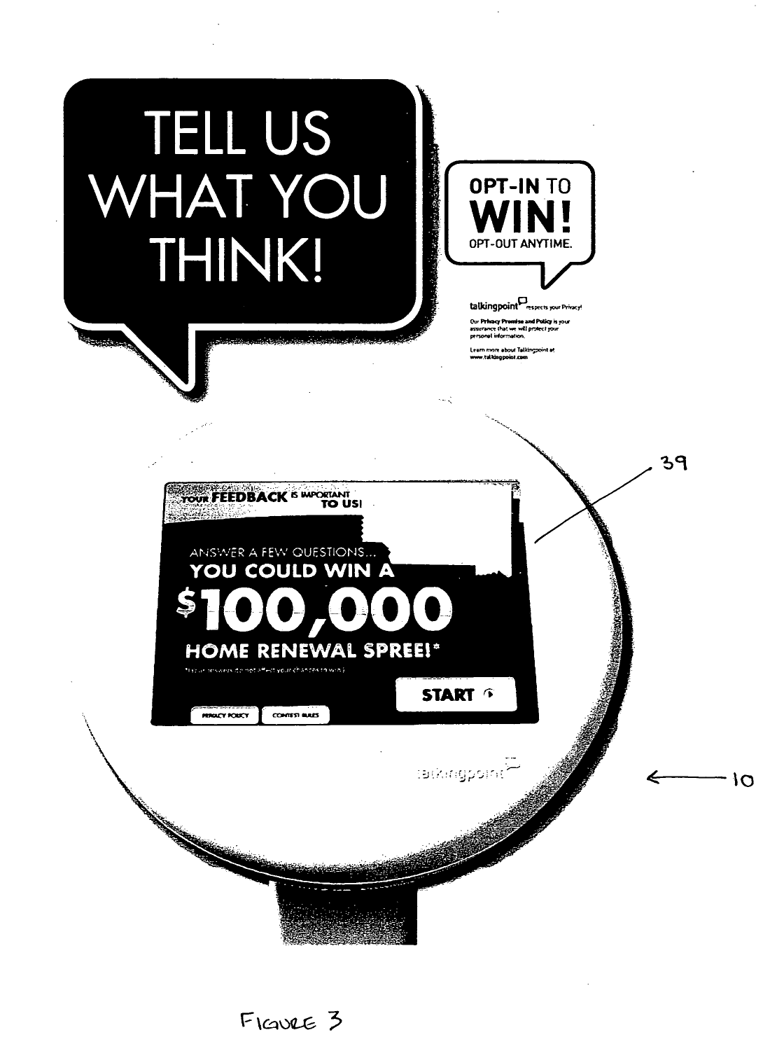

FIG. 2a illustrates a flowchart of one embodiment of the method of the present invention. Each of the blocks is explained more fully below. At block 20, a consumer begins a survey. The consumer may participate in the survey in using a data collection device 10 at a public space such as a retail store. Alternatively, the consumer may participate in the survey via a website. The consumer answers survey questions at block 22. Upon completion of the initial survey, the consumer may be asked to answer additional survey questions at block 24. Rewards offers may be used to entice the consumer to answer the additional questions. The consumer may decline to answer additional questions, as at block 26, or may answer the additional questions, as at block 28. Block 24 may be repeated, optionally with further rewards offers, as many times as desired.

After answering the survey questions, or, alternatively, prior to beginning the survey, the consumer may register, shown at block 30 and a registration confirmation may be sent to the consumer 34. The registration confirmation may be sent via e-mail, regular post, or via any other suitable carrier. Generally, the registration confirmation is sent after the provider receives transmission of consumer registration information and survey answers. If the consumer has previously filled out a survey at a data collection device 10 or via a website, the consumer need not register again but may instead provide identifying information such as an address, username, or other.

Thus, at block 32, the provider receives real-time transmission of the consumer's registration information and survey answers. Real-time indicates only that the information may be transmitted relatively immediately upon registering and completing the survey; instantaneous receipt of the information is not required. Further, survey information may be bundled in groups such that the information is transmitted every set time interval, such as every 15 minutes. The registration information and/or survey answers are compiled into a database at block 36. At block 38, the gathered information is formatted into reports. The gathered information is reported to a commissioning entity, such as a retailer, commissioning the survey at block 38. The reported information may be accessible, for example, via the internet. The information may be reported as raw, unformatted information or may be reported as formatted information. For example, a one-click print option may be provided at block 36 to print reports compiled in accordance with the present invention, discussed more fully below. Using the one-click print option, data manipulation and human error are largely prevented. Alternatively, as is discussed more fully below, the commissioning entity may be provided with several options for customizing the report with specific information. This customization may be referred to as custom data download.

A commissioning entity can use the gathered information to see relative/absolute performance information for each store based on survey questions. The reporting and use of data in accordance with the present invention is discussed more fully below.

FIG. 2b illustrates a flowchart of data collection using one embodiment of the present invention. A data collection device 21 gathers research 23 and registrations 25. The registrations 25 may comprise email addresses 27, U.S. mail addresses 29, or client specific registration codes 31. The client specific registration codes 31 may be tied to a loyalty identification number, a telephone number, or credit card information. The registration information may be used for real time communication initiatives. Further, the registration information may be coupled with survey information for use for real time, real target communications initiatives. Email addresses 27 may be used to send a confirmation of sweepstakes entry, e-coupons, surprise offers, real-time real target offers, or other email initiatives. U.S. mail addresses 29 may be used to send catalog mailings, printed coupon mailings, or other direct marketing initiatives.

The gathered research 23 generally comprises completed surveys 33 and/or demographic information 35. The gathered research 23 may be subject to online reporting and/or real-time, real target segmentation. The aggregated data from the gathered research 23 and the registrations is joined and stored in a database 37, generally at the server 14 of FIG. 1. The aggregated data may be integrated with a client database 39 of the commissioning entity or retailer.

In use, a commissioning entity such as a retailer commissions a survey for gathering consumer feedback or other information. The provider creates a campaign for the commissioning entity based upon business, marketing, merchandising, research or other objectives of the commissioning entity. In alternate embodiments, someone other than the provider may create the campaign. Generally, a campaign includes an overall campaign objective, research objectives, an incentive strategy, merchandising opportunities, and a registration confirmation response to each consumer. Any given campaign may include additional components and/or may not include each of the listed components. Examples of each of the listed components are given below. After these components have been developed, a survey is created for attaining goals of the campaign. When launched, a campaign typically includes an incentive to participate, a short, focused survey, and a request for registration.

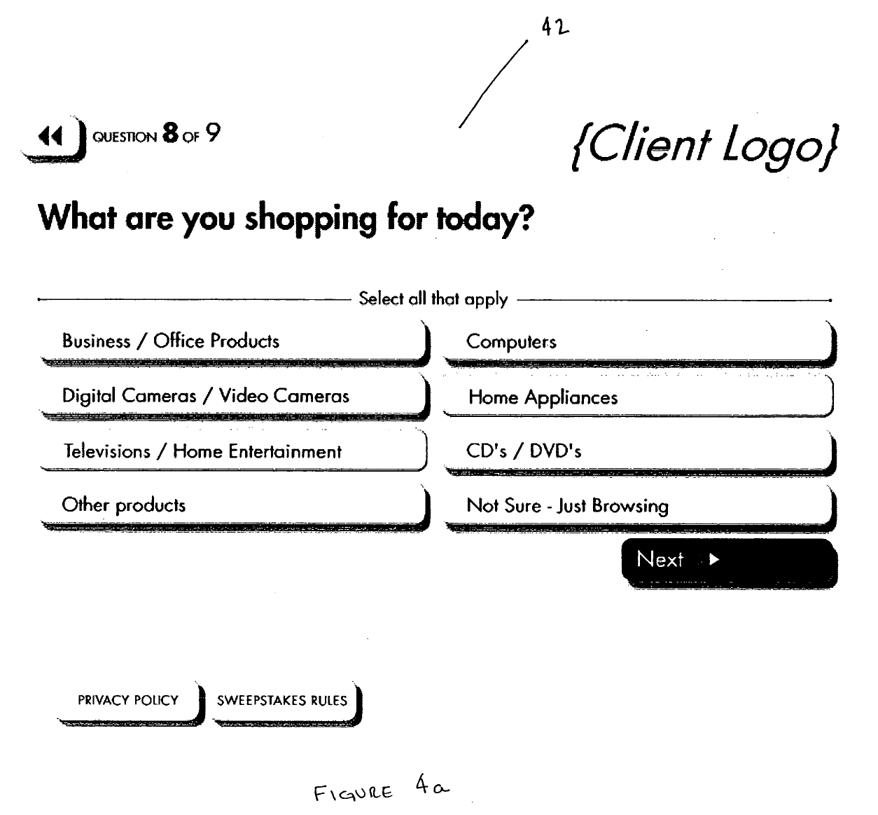

In accordance with the present invention, a consumer is attracted by an incentive to fill out a survey. For example, the data collection device 10 at the remote location 12 may advertise entry into a drawing for a vacation upon filling out a survey. FIG. 3 illustrates a data collection device 10 advertising a home renewal spree incentive 39. Of course, any other suitable incentive may be used. Alternately, no incentive may initially be advertised.

At block 30 of FIG. 2, the consumer registers at the data collection device 10 by providing a contact address. Preferably, the contact address is an email address. Alternatively, the contact address may be a physical email address or other contact information. Further, the registration process may request that the consumer input demographic information such as their gender, age, household income, etc. The consumer may skip demographic questions. Thus, the only information required for registration in accordance with the present invention is a contact address.

Registration triggers a registration confirmation response at block 34 of FIG. 2. In one embodiment, the response is immediate and via email. The response may be specifically tailored to the campaign. The response may include a return incentive, that is, an incentive to cause the consumer to return to a site of the commissioning entity, such as a retail location or website. For example, the response may include a coupon for their next purchase—or other suitable incentive offer. The response may be used to convert a retailer location shopper into a web shopper. The response may further be tailored to registration information provided by the consumer. For example, where the registration process requested gender and age information, the registration response may be tailored to women over 40, men under 30, etc.

Each survey is designed to engage the consumer and gather feedback from the consumer. A survey created in accordance with the present invention is generally brief and focused. Many standard surveys currently available are long and administered in phone or in person. The present invention gathers specific consumer feedback in a relatively short time span without requiring the consumer to interact with persons administering the survey. A typical survey in accordance with the present invention includes approximately 7-10 initial questions with options for answering more questions. The survey generally takes approximately 2-3 minutes to complete. Of course, the number of survey questions and the survey length may vary. A shorter survey is appealing to consumers in that it does not take a large amount of their time. The approach is also appealing to commissioning entities in that it presents clear, actionable results in real time. The consumer answers survey questions at block 22 of FIG. 2. The consumer may be given the opportunity to skip a question.

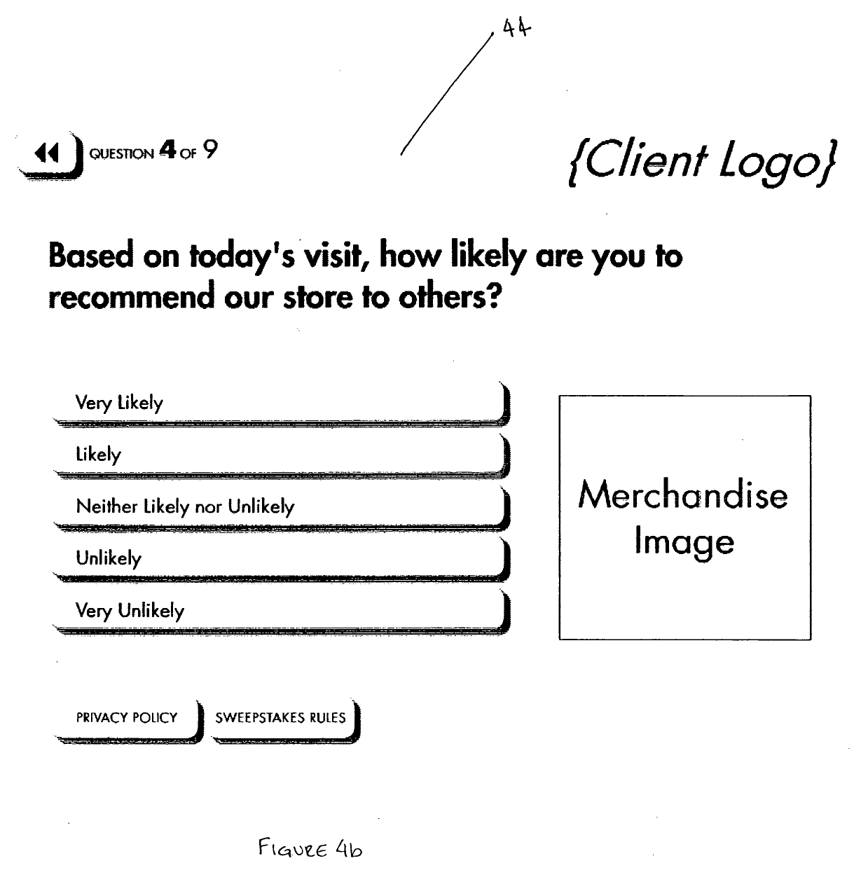

A survey created in accordance with the present invention may incorporate traditional features of surveys such as scales, branching, multi-selects, or other research tenants. Generally speaking, the questions in the survey have more than one answer. The questions may be single choice, multiple-choice, answer, rank, order, or other type questions. The questions may branch such that ongoing questions are based on specific answers to previous questions. Further, the questions may optionally be unstructured such that the consumer articulates their answer in an uncontrolled manner. FIG. 4 illustrates sample survey sheets 42 and 44 in accordance with one embodiment of the present invention. As shown, a survey question may ask for what a consumer is shopping, as at sheet 42, or how often the consumer shops at a store of the commissioning entity, as at 44.

In a situation where the same question is asked in multiple campaigns, the system and method can track answers to the question through the multiple campaigns. Such tracking helps establish an index. Answers may be associated with organizational specific criteria.

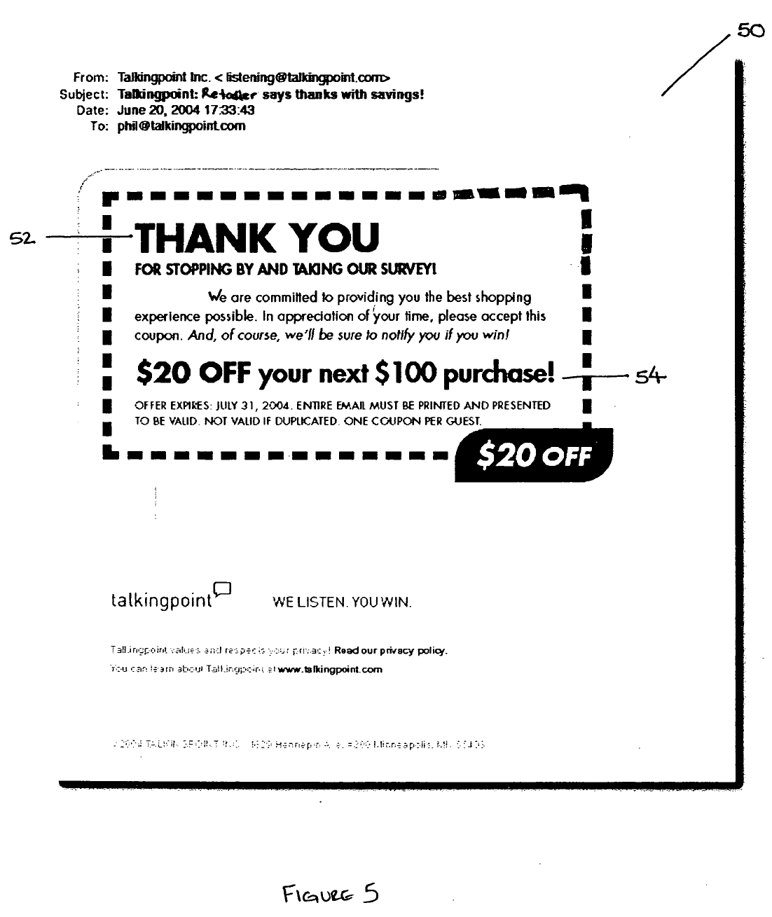

The present invention provides a method for leveraging the relationship assets gathered at the data collection device(s) 10. Based on customer feedback and registration information gathered, a variety of opportunities may be generated. For example, the retailer (or other commissioning entity) can send “thank you” emails or exclusive offers to the consumer. An example thank you response 50 is shown in FIG. 5. As shown, the response 50 includes a thank you message 52 and an offer 54. The offer 52 shown is an offer for $20 off of a $100 purchase. The offer may be any other suitable offer. Thus, the consumer is incentivized to return to the store. Generally, incentives may be attached to specific question answers.

Similarly, the commissioning entity may send real-time, real-targeting offers based on specific answers to questions in the survey. For example, the survey may ask what the consumer generally shops for at the store (e.g., electronics, household items, music, etc.). If the consumer answers “electronics”, then a coupon towards an electronics purchase may be sent. The commissioning entity may use the survey information and/or registration information to convert a consumer from a retail store consumer to a web server by, for example, sending a coupon towards an online purchase. Further, the commissioning entity can address consumers who indicated they were dissatisfied when answering the survey by apologizing and/or declaring a commitment to improve whatever dissatisfied the consumer. The method and system enable commissioning entities to develop relationships and an ongoing dialogue with the consumer that can be maintained over time.

The registration information and/or survey answers are compiled into a database at block 36 of FIG. 2. In one embodiment, the database is shared between the commissioning entity and the provider for use in continuing an ongoing dialogue. The database of profiled customer registration grows in value over time as consumers return to the remote locations and provide additional feedback. Alternately, a survey may be provided on a website and a consumer may provide additional feedback (or original registration and survey information) via the survey on the website. The database of registrations, along with answers to the survey questions, provide sales generating and loyalty building opportunities, discussed above. The database may be queried, to produce a report, for particular groups of respondents, for example women over 30 or men shopping during daytime hours. The database may be used for determining the cumulative response to any given question.

The system of the present invention provides an online reporting tool to enable the commissioning entity to view the customer survey results in real time. In accordance with the invention, the commissioning entity can create and print reports based on at least the following interactive criteria: campaign, remote location(s), date range, day part, demographics, or custom criteria. This creates a custom data download. Further, the reports may be arranged based upon a specific answer. Cross-tab functionality may be provided, for example, a report may be generated providing the information as to how persons who answered “satisfied” to question 2 answered other questions.

In one embodiment, the online reporting tool provides a Flash user interface that reports the gathered information in a focused, actionable format. The reports may be downloaded for example into a spreadsheet such as Excel. The commissioning entity may be given the opportunity to view the report and view interactive criteria chosen for each location, for example to view a report for a location, a time and demographic parameter. Thus, one report could provide information related to New York locations, day time answers, and male users. A “one-click” functionality may be provided such that the commissioning entity may view the information with one click. Further, “master download” functionality may be provided to gather information for all stores based on the same criteria. A simple “view report” functionality may be provided showing the number of respondents, a raw data sheet, and a formatted data sheet.

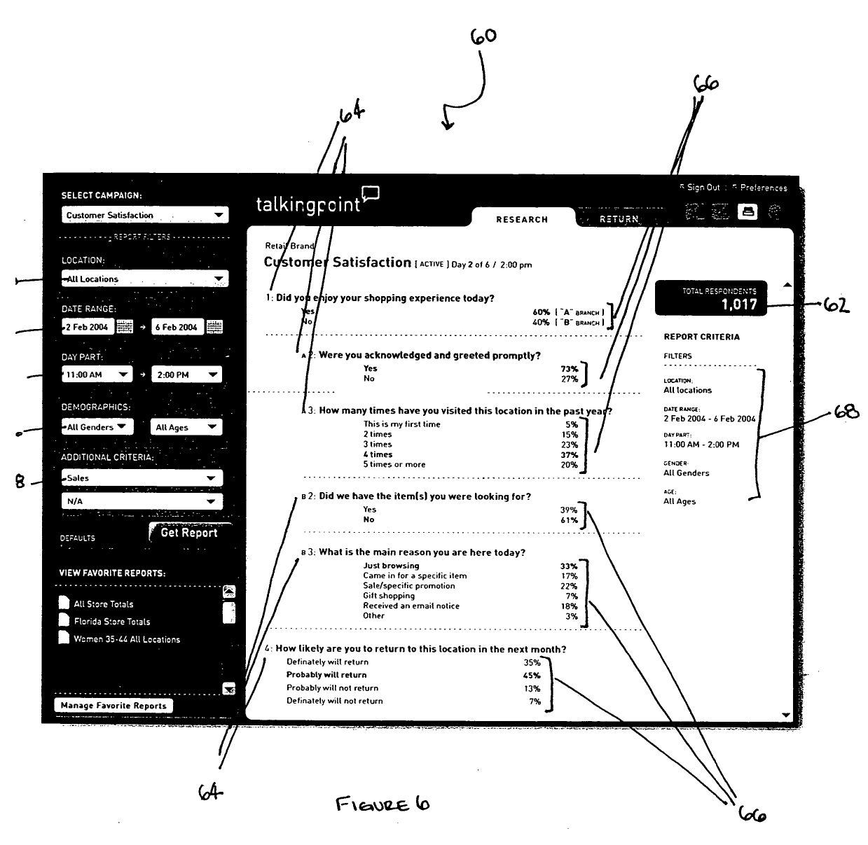

As discussed in relation to block 38 of FIG. 2, the survey information is formatted into reports. FIG. 6 illustrates an example report 60. The report 60 is formatted according to selection criteria requested by the retailer (or other commissioning entity). For example, the report 60 may be formatted using gender, age, store location, or other. Further, the report 60 may be automatically generated and transmitted to the retailer or other commissioning entity. For example, the report 60 may be automatically generated and printed on a selected printer. The Flash interface (e.g. Macromedia Flash 7.0) sizes the report as desired. Using a one-click print option, data manipulation and human error are largely prevented. As seen in FIG. 6, the report 60 details the total respondents 62, the questions asked 64, the percentage of consumers answering in each manner 66, the report criteria 68, or other information requested by the retailer. In the embodiment shown, the report can be set based on various criteria including location 70, date range 72, day part 74, demographics 76, or other criteria 78.

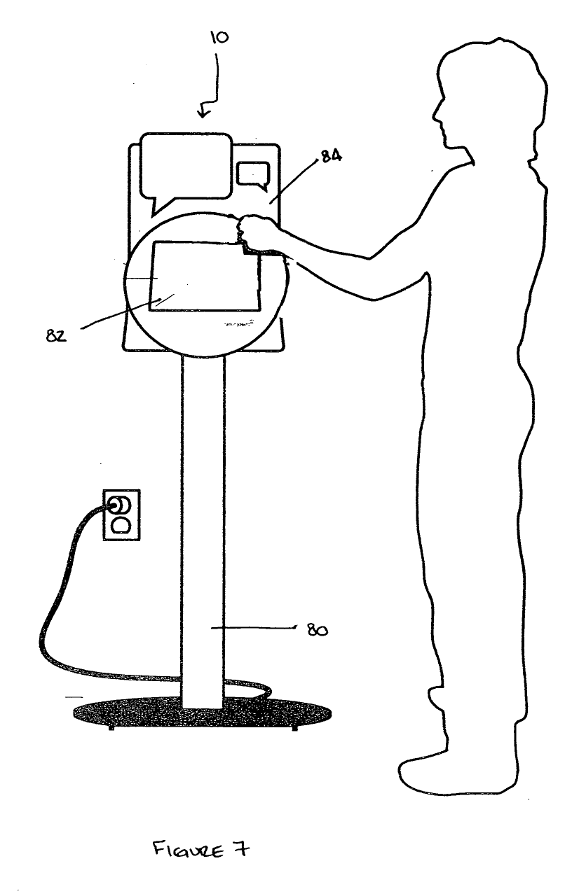

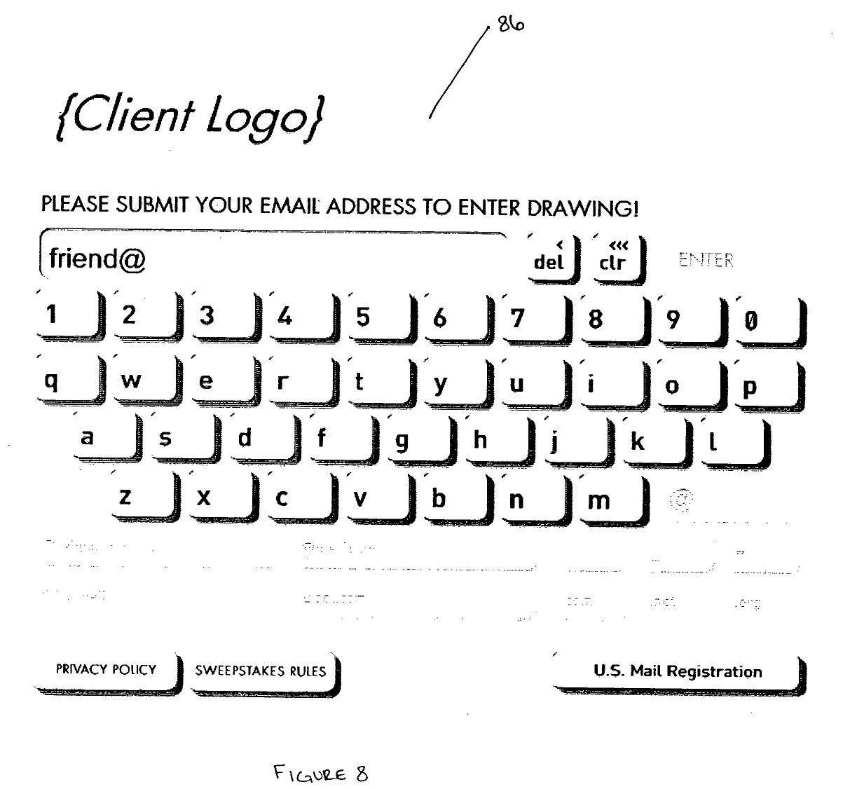

FIG. 7 illustrates an exemplary embodiment of a data collection device 10. As shown, the data collection device 10 includes a stand 80 and screen 82 mounted on a display 84. The stand 60 is optional; the data collection device 10 display 84 may be otherwise mounted. Each data collection device 10 includes an input device for use by the consumer in inputting information. As shown in FIG. 8, the inputting device may be a virtual keyboard 86 on the screen 82 of the data collection device 10.

In a specific embodiment, the data collection device 10 utilizes a touchscreen monitor powered by an ×8.6 based motherboard encased in a custom assembly. The custom assembly may be an injection molded plastic case. A linux operating system is used. The wireless connectivity may be via an external wireless device connected by UIB or PCMCIA (using a universal PC slot).

In order to standardize communication, in one embodiment, a webserver is provided on the talkinpoint station 10. Thus, the talkingpoint software application (discussed below), the presentation to the consumer, and the communication server are all provided within the data collection device 10.

Each data collection device 10 continuously gathers data based on events and time such that there are no holes in the data stream. In the embodiment shown, each data collection device 10 functions autonomously. More specifically, the data collection device 10 shown requires no connectivity to an existing IT infrastructure and operates independent of any staff intervention from the retailer (or other commissioning entity). The survey is thus usercentric with a customer focus.

The data collection device 10 runs the campaign. In one embodiment, the data collection device 10 is configured to change or update the campaign automatically or upon instructions from the server 14. Thus, new campaigns may be communicated to the data collection device 10 from the server 14 in advance of the scheduled run of the campaign. In such situation, the data collection device 10 has instructions regarding when to run the campaign and will replace the old campaign with the new campaign at that time. This is especially useful when the campaign switch coincides with a sweepstakes rule. For example, when a sweepstakes must be entered by a certain date, the campaign being run may be changed on that date. In one embodiment of the invention, campaigns typically run for approximately 6-8 weeks.

Communication independent of connectivity is achieved by providing wireless communication capabilities in the data collection device 10. For example, the data collection device 10 may be configured with a wireless communication device such as a global system mobile (GSM)/third-generation (3G) device. Using current GSM/3G technology, the payload must be relatively small. Thus, data gathered at the data collection device 10 is bundled and compressed for transmission. Optionally, the data may be encrypted for added security. In a specific embodiment, PVT encryption is used to protect the payload. The data is sent via a standard API (e.g., http) to the applications server 14. Generally, survey results are bundled for sending approximately every hour. Alternately, the survey results may be sent in real time. Of course, other wireless communications technology may be used and, as such technology advances, it may not be necessary to send the data via small payloads. Further, it is possible to configure the data collection device 10 to communicate via a connectivity of the retailer. For example, the data collection device 10 may be provided with modem, Ethernet, or other capabilities.

The data collection device 10 may be programmed to periodically communicate with the server 14 regardless of whether there is data to be sent. This is useful when it is desired to limit communication from the server 14 to the data collection device 10 except for when the data collection device 10 has initiated communication. By so limiting communication, access to the system by hackers is minimized. The data collection device 10 is configured to receive information from the server 14 as well as to send data to the server 14.

The server 14 monitors the data collection devices(s) 40, processes information from the station(s) 10 and maintains the stations(s) 40. Monitoring the station(s) 10 involves checking the functionality of the station(s) 10. Processing information from the station(s) 10 includes receiving data from the station(s) and/or compiling such data into reports. Maintaining the station(s) 10 involves checking and/or updating campaign status.

The server 14 monitors the functionality of each data collection device 44 remotely. The server 14 may be configured to monitor the functional speed, the temperature, and the disk space available for each data collection device 44. This may be done using the communication capabilities of the data collection device(s) 44—thus, via a GSM/3G system or other communication system. As discussed above, in one embodiment, the server 14 cannot communicate with the data collection device 10 unless the data collection device 10 has initiated communication with the server 14.

When the server 14 is in communication with the data collection device 10, the server 14 can maintain the station 10 by, for example, updating the campaign. This may involve communicating a new campaign or activating a preloaded campaign. It may be preferable to do maintenance (e.g., publishing a new campaign) at night when traffic on the communication network is reduced.

Upon receipt of data from the data collection device 10, the server 14 may be configured to send a notification of receipt to the station 10. At that point, the data collection device 10 may delete the data sent. Generally, in accordance with the invention, gathered data is not deleted from the data collection device 10 until confirmation of receipt of the data is sent. This minimizes risk of data loss. Before sending the notification of receipt to the station 10, the server 14 may validate the data. Validation may include decrypting the data, confirming that the data is related to the correct campaign, confirming campaign name, confirming that the data is related to the correct consumer, confirming that the data is for the correct commissioning entity (for example, the correct retail chain), confirming that the data is for the correct store, confirming intra-store location, checking for copies, etc. The server 14 inserts the data into a database. The server 14 may further normalize the data, for example by adjusting for time zones.

The server 14 may precalculate answers. This is typically done with research wherein the retailer (or other commissioning entity) interacts with the reporting database.

The server 14 does an initial analysis for the data. This includes determining whether the survey was completed, whether the information provides contact information. If the survey is complete, it is marked as complete. Alternately, if there is a problem with the survey, the problem is marked.

A default response may be established to each survey wherein, upon receipt of the survey and initial analysis of the survey, the default response is sent to the consumer. Further, specific answers to specific survey questions may prompt additional action. For example, a dissatisfaction answer may prompt an apology email. Other examples of specific actions may be to send a coupon, an entry to a sweepstakes, etc. Engines may be provided for sweepstakes, coupons, or other incentives.

Further non-report-type processing of the data may be done. For example, the data may be analyzed to determine how long it takes consumers to answer each question. Such information may be useful for loading on the data collection device 10. That information may be used to set a maximum time for answering a question before the survey resets—thereby resetting the survey when a consumer walks away from the station 10. Conversely, the information can be used for detecting fraud, for example, when answers are provided too fast and it is likely that the consumer is filling out the survey merely for the incentive without truly answering the questions. Further processing may include validating the uniqueness of the contact information given, for example, email or postal address. After a registration confirmation has been sent to the contact address and, if such confirmation is not returned, the address may be marked as validated. Of course, any of this processing data may be included in a report if desired.

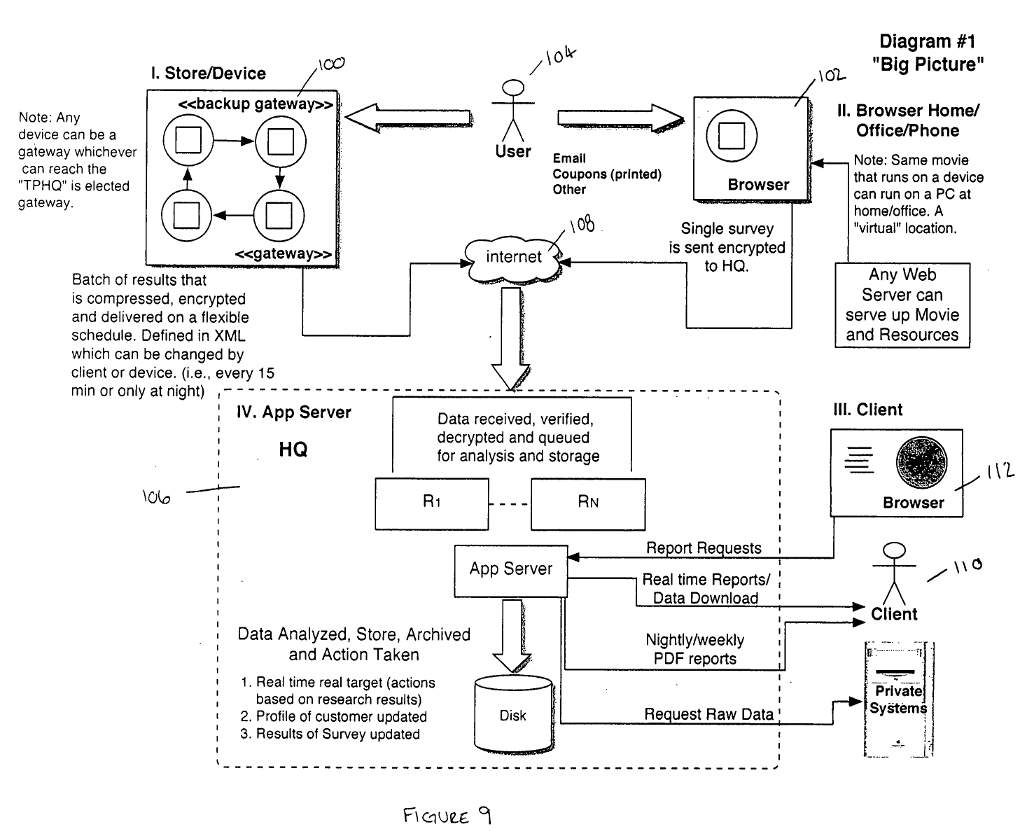

FIG. 9 illustrates an overview of a data collection system. A survey is accessible through a data collection device 100 or through an internet browser, a telephone, or other suitable device 102. Generally, any web server may serve up a survey and associated resources. Regardless of the manner of accessing a survey, a user 104 answers survey questions and provides results. During user interaction with the survey, or interactive multimedia interview, the interactions are recorded. For example, the selections by the user, how long it took to make the selections, etc. may be recorded. Once the survey is complete, the information is sent to the provider server.

Typically, in the device 100 configuration, survey results are batched, that is, several survey results are stored together on an application server, and periodically sent to the provider server 106. In contrast, in a browser 102 configuration, single survey results are sent to the provider server 106. Generally, as discussed above, the survey results are sent via the internet 108.

Once received by the provider server 106, the data is verified and queued for analysis and storage. If the data was encrypted for transmission, the data is decrypted. The data is analyzed, stored and archived. The data may be stored in a database. In one embodiment, the database is open to the commissioning entity 110 such that they can view the raw data. This can be done via a user interface or a simple program.

Action may be taken on the data such as real time real target actions—actions based on research results. Further, as users participate in multiple surveys, the customer profile may be updated. The client 110, or commissioning entity, can access the data via an internet browser 112 or other suitable means. The client 100 can request specific reports, download data or real time reports, receive nightly/weekly reports, or receive raw data.

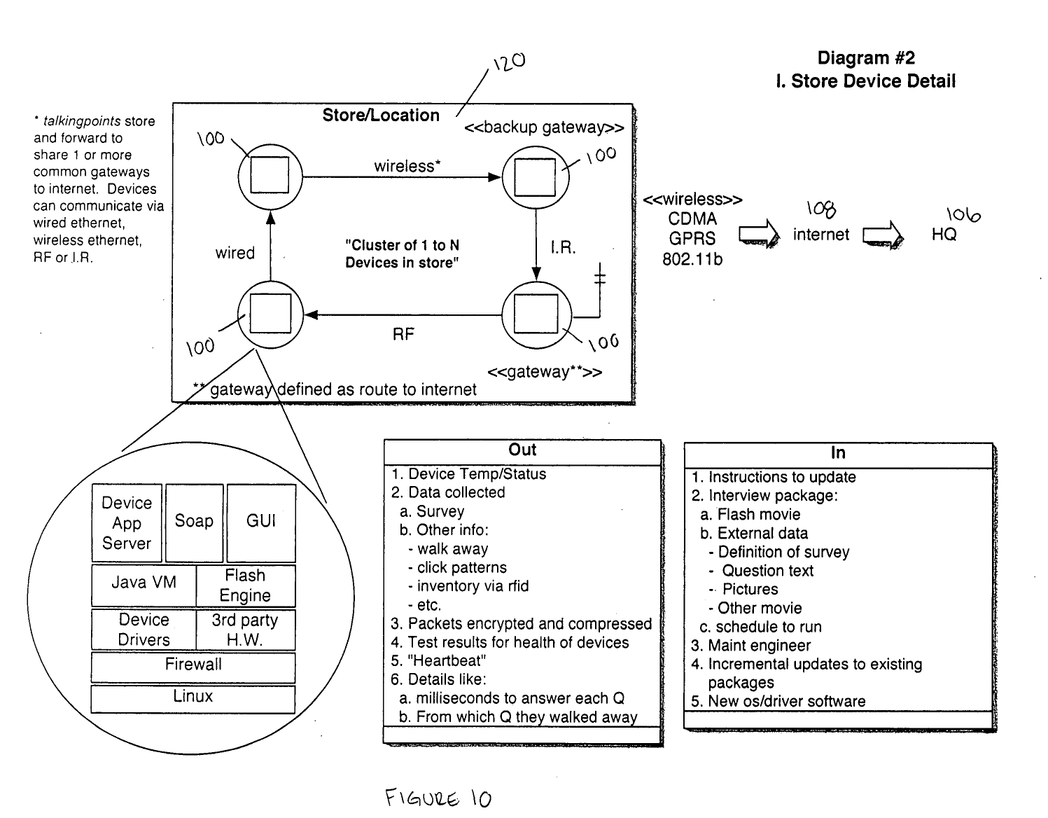

FIG. 10 illustrates a block diagram of data collection device detail in accordance with one embodiment of the present invention. Several data collection devices 100 may be provided at one location 120. These devices may communicate among themselves via, for example, wired Ethernet, wireless Ethernet, RF, I.R., or other suitable communications technology. The several data collection devices 100 may be configured such that they share one or more common gateways to the internet 108. The data collection devices 100 transmit data to the provider server 106 via the one or more gateways.

The data collection devices 100 may interact via a chain of command. Thus, in one example, device A in store A forwards its package to device B in store A. Device B then transmits the information to the provider server. Device B may receive update or patch commands from the provider server and these commands are moved transparently back to device A through device B. Thus, in this example, device B is acting as the gateway. This gateway enables many devices in a location to share a common gateway to the internet.

Generally, the data collection devices 100 receive and transmit information to the provider server 106. For example, the data collection devices 10 may receive instructions to update, a survey package, maintenance information, updates, new software or other. The survey package may include a flash interactive multimedia interview, external data such as the definition of the survey, question text, pictures, or another survey, and a schedule to run. Information transmitted to the provider server 106 by the data collection devices 100 may include device status, including, for example temperature, data collected, encrypted and/or compressed packets, test results for health of the data collection devices 100, various details, or other. Collected data may include the survey results, whether the user left the data collection device 100 without completing the survey, click patterns, inventory, or other. Related, details may include the amount of time taken to answer each question or at what question the user left the data collection device 100. If no data has been collected in a specified period of time, the data collection device 100 may transmit device status and version information as a “heartbeat” to indicate that the device 100 is functional.

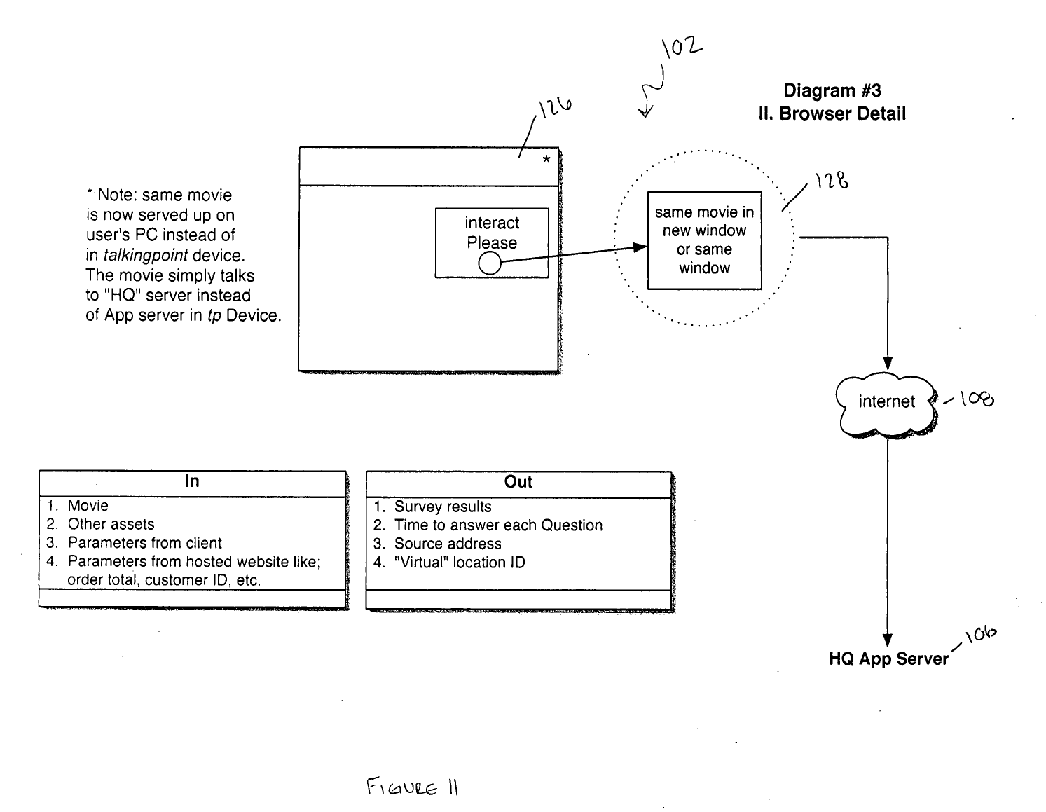

FIG. 11 illustrates detail regarding data collection via a browser 102. In a browser 102 configuration, the data is transmitted directly to the provider server 106 rather than temporarily stored on an application server. A user is prompted to participate in a survey, shown at 126. The survey loads onto the computer, or other suitable device, for participation by the user, shown at 128. The survey data is transmitted to the provider server 106 via the internet 108. Information that may be loaded when the user indicates interest to participate in the survey include the survey, other assets, parameters from the commissioning entity, parameters from the hosted website such as order total, customer id, etc. The information transmitted to the provider server 106 may include the survey results, the time to answer each question, the source address, and the virtual location ID.

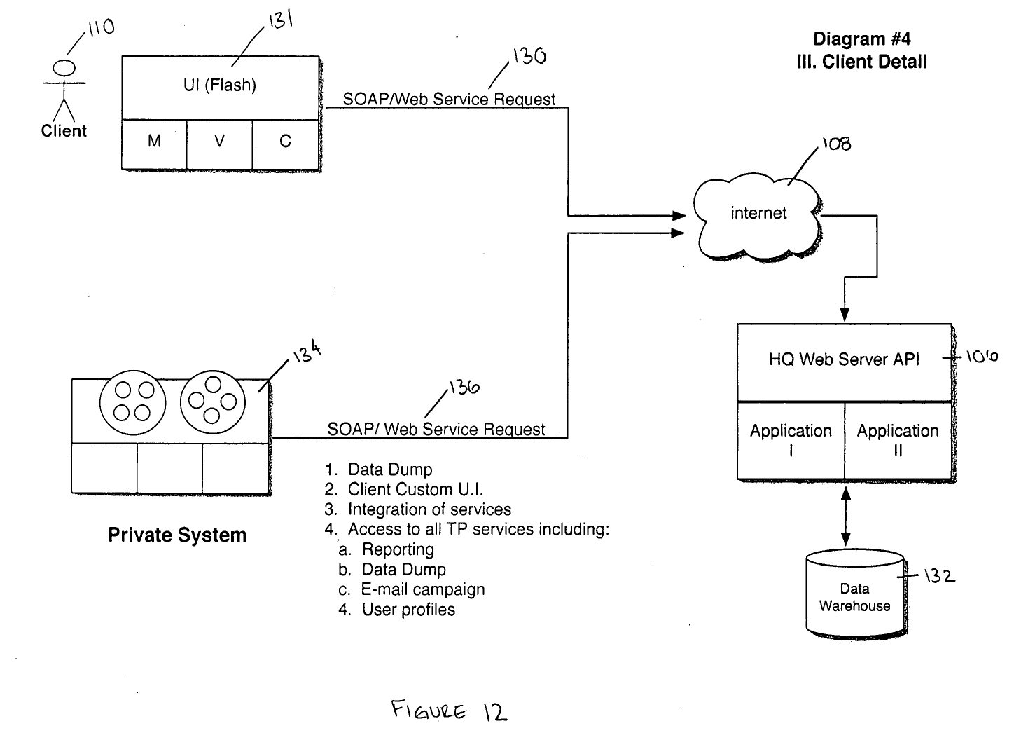

FIG. 12 illustrates a block diagram of the commissioning entity, or client 112, detail. The client 112 may generate a SOAP/Web Service request 130 for data. This request may be generated using a user interface or AUI tool 131. The request 130 is sent to the provider server 106 via the internet. As previously discussed, after a user 104 participates in a survey, data is sent to the provider server 106. The data may be stored in a data warehouse 132. Pursuant to the request 130, data may be pulled from the warehouse 132 and returned to the client 112. Via the request 130, the client 112 is able to view reports of the surveys that have been received. A private system 134 may be provided from which the client 112 may access information regarding the data using, for example, a SOAP/Web Service request 136. The system may provide a data dump (raw data), client custom user interfaces, integration of services, or access to all data collection services. Data collection services may include, for example, reporting, data dump, e-mail campaign, and user profiles. Using the private system 134, the client 112 has the option to request data downloads of survey data to their private computer systems.

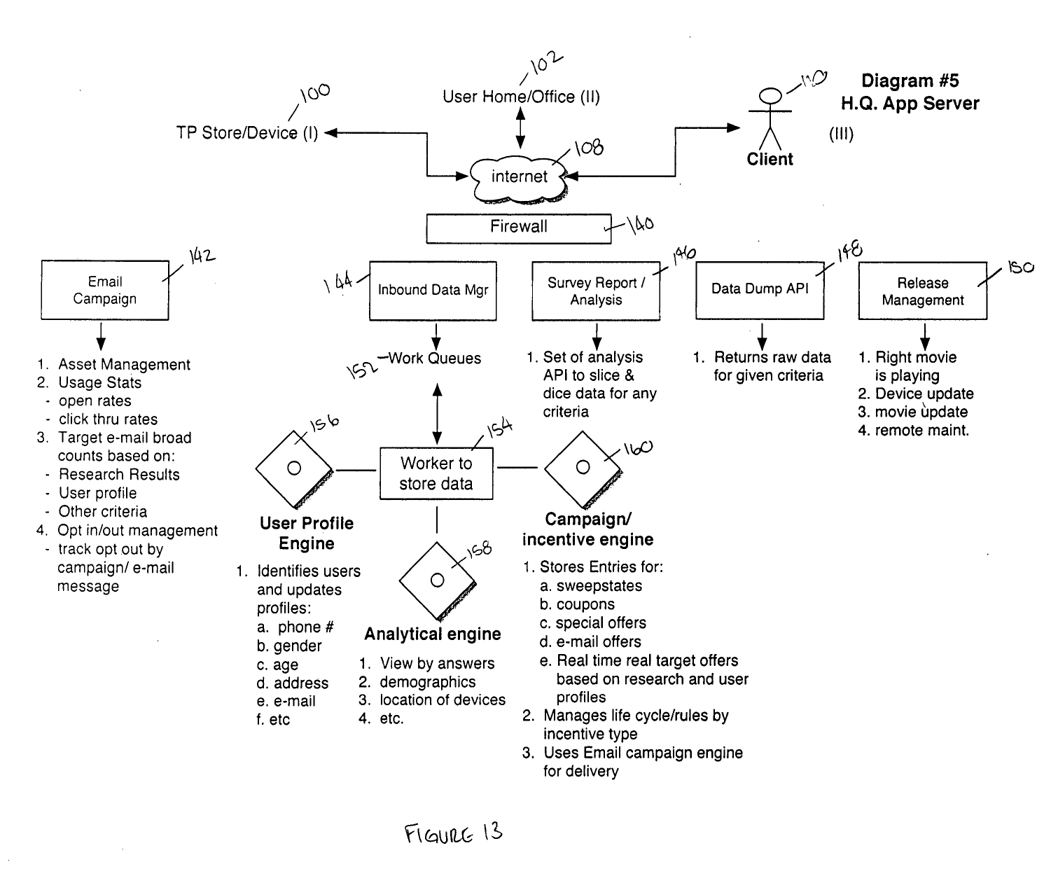

As shown in FIG. 13, a data collection device 100, a browser 102, and a commissioning entity 110 may all interact with the provider server. Typically such interaction is via the internet 108. However, any other suitable means for interaction may be used. A firewall 140 may be provided to protect the provider server. The provider server includes several components. For example, the provider server may include a campaign 142, an inbound data manager 144, a survey/report analysis component 146, a data dump API 148, and a release management 150.

The email campaign 142 on the provider server may include asset management, usage statitistics, target e-mail broad counts, or opt in/out management. The usage statistics may include, for example, open rates and click thru rates. The target e-mail broad counts may be based on research results, user profile, or other criteria. The opt in/out management may track opt out by campaign or e-mail message.

The inbound data manager 144 queues the data into work queues 152 for analysis and storage. That data is stored 154 and may be used by a user profile engine 156, an analytical engine 158, and/or a campaign/incentive engine 160. The user profile engine 156 identifies users and updates profiles. Updated information may include phone number, gender, age, address, e-mail, or other information. The analytical engine 158 views the data by answers, demographics, location of data collection devices, etc. The campaign/incentive engine 160 stores entries for, for example, sweepstakes, coupons, special offers, e-mail offers, real time real target offers based on research and user profiles, or other offers. The campaign/incentive engine 160 further manages the life cycle and rules of the incentive by incentive type. The campaign/incentive engine 160 may use an email campaign engine for delivery.

The survey report/analysis component 146 comprises a set of analysis API to sort data for any criteria.

The data dump API 148 returns raw data for given criteria.

The release management 150 ensures that the correct survey is loaded, checks data collection device updates and/or updates the data collection device, updates surveys, and performs remote maintenance.

Thus, as is generally illustrated in FIGS. 9-13, a user participates in a survey, or interactive multimedia interview, and the interactions of the user with the survey are recorded. Once the survey is completed, or if the survey times out, the information is stored in an application server of the data collection device or sent to a provider server. The application server stores the information in a local queue, sends a “notify” signal to the worker thread, described below, and replies “OK” to the survey. A failure to do so may also be communicated. If there has been no survey interaction for a preconfigured period of time, the interactive multimedia interview transmits data to the provider server to confirm functionality.

A separate worker in the application server may be provided to run asynchronously on a device/org/store specific schedule. Such worker is “asleep” until a precalculated interval or “notify” wakes it up. Once awake, the worker thread determines whether it is designated to contact the provider server. This permits “near real time” communication for infrequent communication and “batched” mode communication for frequent communication. If the data collection device is configured to transmit data once an hour and no more than four times in an hour throughout the day, an interaction may be sent immediately if nothing else has been sent in the last 15 minutes. In contrast, if something had been sent within the last 15 minutes, no further data is transmitted until 15 minutes has elapsed. After the 15 minutes has elapsed, all data collected during that 15-minute interval is sent. In one embodiment, sent indicates that the data is compressed, encrypted and wrapped in a SOAP request and sent to the provider server. Once the provider server replies “OK,” the data collection device removes the data from the local outbound queue.

With each data package, the data collection device further transmits device status and version information. If no data is available, device status and version information is sent as a “heartbeat” to indicate that the device is functional.

In addition to “OK,” the provider server may notify the device that it is scheduled for an immediate update and should perform the update at that time. This enables the devices to be patched in the field in near real time. Absent such instruction, the device may be configured to check for updates independently each night. Further, the update time may be configurable. The device may also synchronize its clock to the provider server each night to ensure consistent local time of day.

Interactive multimedia interviews are part of an overall package that is delivered to the data collection device. Packages include (1) a flash survey; (2) an interview definition file; (3) a schedule; and (4) external assets for the flash survey. The separation of the user experience into these independent pieces permit significant updates in the field.

The flash survey may be configured as a standard application with client (or commissioning entity) specific assets. Thus, it may follow a structure and flow/timeline as defined in the interview definition file. The definition may be an XML file that may be upgraded while leaving the other assets in place. Thus, a question (or other) may be added, removed, or altered without requiring the entire interactive multimedia interview to be resent.

The schedule generally defines on which days and times the interactive multimedia interview is to run. In the event no interactive multimedia interview is found to run that is schedule, a default interactive multimedia interview may be configured to run. Thus, content may be delivered ahead of schedule and may appear exactly on time for a user. This functionality may be used for sweepstakes, which typically have a definite start and end time.

Within the package, these assets are generally bundled together and compressed for delivery. Upon receipt, the data collection device uncompresses them into a reserved area in the device.

The separation of the interview definition file and the multimedia assets also permits sophisticated interviews to be created by a person with little to no multimedia experience. The person simply specifies a “template movie” and a list of questions and answers. The system packages them together and delivers them to the specified data collection devices.

A sample example of an interview definition file is as follows:

<interview moviename=“movie.swf”>
<schedule>(formatting for schedule) </schedule>
<question id=234 type=multiple choice>
<text>What are your favorite flavors of soda? [select all that
apply]</text>
<answer id=100 nextQID=235 type=“multi” style=“photo
asset=“bottle.swf”>Vanilla</answer>
...
</interview>

Thus, as shown, in one embodiment, the XML definition files drive the process. How the questions are presented, where to send the user given a certain answer, how many incentive points the answer is worth, etc. may be dictated by the XML definition files. XML permits custom properties to meet business needs to be added. For example, alternate definitions by language may be used.

Although the present invention has been described with reference to preferred embodiments, persons skilled in the art will recognize that changes may be made in form and detail without departing from the spirit and scope of the invention.

What is claimed is:

1. A process for gathering consumer feedback comprising:
incentivizing a consumer to participate in a survey;
gathering consumer answers to survey questions;
gathering registration information from the consumer;
transmitting the gathered consumer answers and information to a server;
transmitting a registration confirmation to the consumer;
generating a report based upon the gathered consumer answers and information.

2. The process of claim 1, wherein the step of transmitting occurs in approximately real time.

3. The process of claim 1, wherein the registration confirmation is tailored to the consumer information.

4. The process of claim 1, wherein the report is tailored according to criteria set by a commissioning entity.

5. The process of claim 1, further comprising generating a profile for the consumer based on the consumer answers and information.

6. The process of claim 5, further comprising updating the profile upon gathering of answers to further survey questions by the consumer.

7. The process of claim 1, wherein the survey questions are tailored to a campaign of a commissioning entity.

8. The process of claim 1, further including incentivizing the consumer to answer additional survey questions.

9. The process of claim 1, wherein the registration confirmation includes an incentive for the consumer to return to a site of a commissioning entity.

10. The process of claim 1, further comprising transmitting an offer to the consumer based on the consumer answers and/or registration information.

11. A data collection system comprising:
a data collection device configured to run a campaign, the data collection device including a display and an input device; and
a provider server, the provider server including the campaign and an analysis component, the analysis component being configured for analyzing research gathered by the campaign;
wherein the data collection device is in communication with the provider server and is configured to periodically receive information from or send information to the provider server.

12. The data collection system of claim 11, wherein the data collection device further comprises an application server for monitoring the data collection device and storing information collected by the data collection device.

13. The data collection system of claim 11, further comprising a plurality of data collection devices.

14. The data collection system of claim 13, wherein the plurality of data collection devices are in communication with one another.

15. The data collection system of claim 11, wherein the provider server further comprises a campaign/incentive engine, a user profile engine, an analytical engine, and a release management.

16. The data collection system of claim 11, wherein the information sent to the provider server from the data collection device comprises device status information.

17. The data collection system of claim 11, wherein the information sent to the provider server from the data collection device comprises collected data.

18. The data collection system of claim 11, wherein the data collection device further includes an incentivizing component.

19. The data collection system of claim 11, wherein the information received by the data collection device from the provider server comprises campaign information.

20. The data collection system of claim 19, wherein the campaign information comprises a flash survey, an interview definition file, a schedule, and external assets for the flash survey.
